(19) United States
(12) Patent Application Publication
(10) Pub. No.: US 2024/0112065 A1
(43) Pub. Date: Apr. 4, 2024

(54) META-LEARNING OPERATION RESEARCH OPTIMIZATION

(71) Applicant: Oracle International Corporation, Redwood Shores, CA (US)

(72) Inventors: Amir Hossein Rezaeian, San Mateo, CA (US); Hariharan Balasubramanian, Redmond, WA (US)

(73) Assignee: Oracle International Corporation, Redwood Shores, CA (US)

(21) Appl. No.: 17/934,299

(22) Filed: Sep. 22, 2022

(51) Int. Cl. G06N 20/00; G06K 9/62; G06N 7/00

(52) U.S. Cl. CPC G06N 20/00; G06K 9/6262; G06N 7/005

(57) ABSTRACT

The present disclosure generally relates to systems and methods for operation research optimization. The systems and methods include receiving, at a data processing system, a payload including a request for optimizing a service and processing the payload using a meta learning classifier. The processing includes extracting a problem and use case characteristics from the payload, predicting at least one machine learning model capable of solving the problem having the use case characteristics, and executing the at least one machine learning model to solve the problem. The systems and methods also include outputting a solution to the problem for optimizing the service from the at least one machine learning model, and providing the solution to a computing device.

### FIELD

The present disclosure relates generally to operation research optimization, and more particularly, to techniques for providing an automated data driven framework in choosing the proper approach and model for solving optimization problems.

### BACKGROUND

Operation research in optimization generally relates to the analysis of mathematical problems and designing efficient algorithms for solving the mathematical problems. The goal of operation research is to optimize the object function (e.g., minimize or maximize), while satisfying the object constraints, using the parameter decision variables (integer or non-integer) provided. Depending on the type of data structures, different types of methods are needed to solve the problem. Typically, optimization in operations research involves mathematical formulation that is focused on finding the minimum and maximum of functions based on various constraints. Traditional methods of optimization in the operations research area uses mathematical sciences such as linear programming (LP), non-linear programming (NLP) and mixed integer programming (MIP) to find optimal solutions to complex decision-making problems. Such mathematical models are designed to optimize the object function while satisfying the object constraints using the parameter decision variables (integer or non-integer).

Generalizability of the problem is very difficult within the traditional approaches, which can lead to different issues. Traditionally, a given operations research problem needs to be translated to a mathematical model using a set of statements and data blocks. Then a high-level program, such as a model translator, analyzes the model description and translates the model into internal data structures, which may be then used either for generating mathematical programming problem instance or directly by a program called the solver to obtain numeric solution of the problem. However, every time that the formulation of the problem is changes, for example, by relaxing or removing a set of constrains, the entire this process needs to be repeated.

Additionally, the ability to perform what-if analysis can be critical to achieve the optimized solutions, however, such analysis is based on what-if scenarios which become computationally expensive as number of variables grow (e.g., millions plus). Similarly, sensitivity analysis, which is needed for explainability, is not always possible. There is a need to improve the way operation research is performed.

### SUMMARY

In various embodiments, a method is provided. The method includes receiving, at a data processing system, a payload including a request for optimizing a service and processing, by the data processing system, the payload, using a meta learning classifier. The processing includes extracting a problem and use case characteristics from the payload, predicting at least one machine learning model capable of solving the problem having the use case characteristics, and executing the at least one machine learning model to solve the problem. The method also includes outputting, by the data processing system, a solution to the problem for optimizing the service from the at least one machine learning model and providing, by the data processing system, the solution to a computing device.

In some embodiments, the at least one machine learning model includes one of a mathematical solver, a simulation optimization model, and a reinforcement learning model. The mathematical solver can include programs capable of solving a combination of a linear programming (LP), non-linear programming (NPL), and mixed integer programming (MIP), the simulation optimization model can include programs capable of performing stochastic programming, a Monte Carlo simulation, and a discrete event simulation, and the reinforcement learning model can include a neural network or a deep learning model. The method can further include storing all solutions created by the mathematical solver and all simulation results created by the reinforcement learning model. The reinforcement learning model can be trained using the stored solutions created by the mathematical solver and the simulation optimization model. The reinforcement learning module can compare an output solution to the problem provided by one of the mathematical solver and the simulation optimization model to a solution derived by the reinforcement learning module. The predicting can include determining whether the use case characteristics indicates that the problem is deterministic or stochastic.

In various embodiments, a system is provided. The system includes one or more processors and a memory coupled to the one or more processors. The memory configured to store a plurality of instructions executable by the one or more processors and when executed by the one or more processors cause the one or more processors to at least receive a payload including a request for optimizing a service, and process the payload, using a meta learning classifier. The processing the payload includes steps to at least extract a problem and use case characteristics from the payload, predict at least one machine learning model capable of solving the problem having the use case characteristics, and execute the at least one machine learning model to solve the problem. The plurality of instructions are configured to output a solution to the problem for optimizing the service from the at least one machine learning model and provide the solution to a computing device.

In some embodiments, the at least one machine learning model comprise one of a mathematical solver, a simulation optimization model, and a reinforcement learning model. The mathematical solver can include programs capable of solving a combination of a linear programming (LP), non-linear programming (NPL), and mixed integer programming (MIP), the simulation optimization model can include programs capable of performing stochastic programming, a Monte Carlo simulation, and a discrete event simulation, and the reinforcement learning model can include a neural network or a deep learning model. The system can further include storing all solutions created by the mathematical solver and all simulation results created by the reinforcement learning model. The reinforcement learning model can be trained using the stored solutions created by the mathematical solver and the simulation optimization model. The reinforcement learning module can compare an output solution to the problem provided by one of the mathematical solver and the simulation optimization model to a solution derived by the reinforcement learning module. The predicting can include determining whether the use case characteristics indicates that the problem is deterministic or stochastic.

In various embodiments, a non-transitory computer-readable memory storing a plurality of instructions executable by one or more processors is provided. The plurality of instructions comprising instructions that when executed by the one or more processors cause the one or more processors to perform operations including receiving a payload including a request for optimizing a service and processing the payload, using a meta learning classifier. The processing includes extracting a problem and use case characteristics from the payload, predicting at least one machine learning model capable of solving the problem having the use case characteristics, and executing the at least one machine learning model to solve the problem. The instructions also include outputting a solution to the problem for optimizing the service from the at least one machine learning model and providing the solution to a computing device.

In some embodiments, the at least one machine learning model comprise one of a mathematical solver, a simulation optimization model, and a reinforcement learning model. The mathematical solver can include programs capable of solving a combination of a linear programming (LP), non-linear programming (NPL), and mixed integer programming (MIP), the simulation optimization model can include programs capable of performing stochastic programming, a Monte Carlo simulation, and a discrete event simulation, and the reinforcement learning model can include a neural network or a deep learning model. The instructions can further include storing all solutions created by the mathematical solver and all simulation results created by the reinforcement learning model. The reinforcement learning model can be trained using the stored solutions created by the mathematical solver and the simulation optimization model. The reinforcement learning module can compare an output solution to the problem provided by one of the mathematical solver and the simulation optimization model to a solution derived by the reinforcement learning module. The predicting can include determining whether the use case characteristics indicates that the problem is deterministic or stochastic.

### BRIEF DESCRIPTION OF DRAWINGS

FIG. 1 is a block diagram illustrating one pattern for implementing a cloud infrastructure as a service system, according to at least one embodiment.

FIG. 2 is a block diagram illustrating one pattern for implementing a cloud infrastructure as a service system, according to at least one embodiment.

FIG. 3 is flowchart depicting a processes implementing a cloud infrastructure as a service system, according to at least one embodiment.

FIG. 4 is flowchart depicting a processes implementing a reinforcement learning model, according to at least one embodiment.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

### Introduction

The present disclosure provides a mechanism for solving operation research problems through meta learning using ensemble learning technique supplemented with the deep reinforcement learning and simulation optimization. Optimization services are aimed at helping companies optimize their business processes in areas of operation research optimization (optimization research) with different use cases for different verticals including but not limited to supply chain management, procurement, resource allocation, scheduling (staffing, queuing) and inventory optimization (single inventory, multi-inventory). Each of the verticals can include different types of problems depending on use cases and various constraints and data. The present disclosure provides a framework that can solve multiple problems within different verticals.

Operation research problems often rely on manually applying domain-knowledge to decide what approach and solver (or model) is useful for providing a solution to the particular operation research. However, if variables change, then the optimization needs to be manually redone from scratch. The present disclosure implements an artificial intelligence automated data-driven framework that leverages machine learning to analyze a problem payload to choose right approach and a right model. The artificial intelligence automated data-driven framework can be implemented such that it is use case agnostic. The present disclosure generalizes the problem by incorporating more use cases and creating a unique combination of models that can be applied across multiple verticals. For example, a catalog of use-cases can be created in a database using characteristics of the use-cases and then a learner can classify the use-cases in terms of operations research problems. These optimization research problems may be solved using a combination of mathematical programing using solvers, using stochastic approaches and simulations, and/or reinforcement learning based models.

One of the main challenges of such service is that even within a vertical like Resource Allocation or Inventory Optimization when some of input parameters are not more deterministic and become stochastic, then the mathematical solvers are not reliable, and one needs to switch to a new model like Simulation or/and Reinforcement-Learning based models. The transition between these models is a big challenge. The challenge can be related to deployment of multi-models in the production. Every model has its own docker image which needs to be maintained and deployed. In the present disclosure, only a single deployment is needed. In this way the continuous integration and continuous deployment (CI/CD) pipeline and deployment are managed much simpler. The present disclosure provides an artificial intelligence approach to solve this problem by building a meta learning model which automates switching between various models including both machine-learning and traditional models (e.g., linear programming, mixed integer programming, non-linear programing, etc.).

### IaaS System

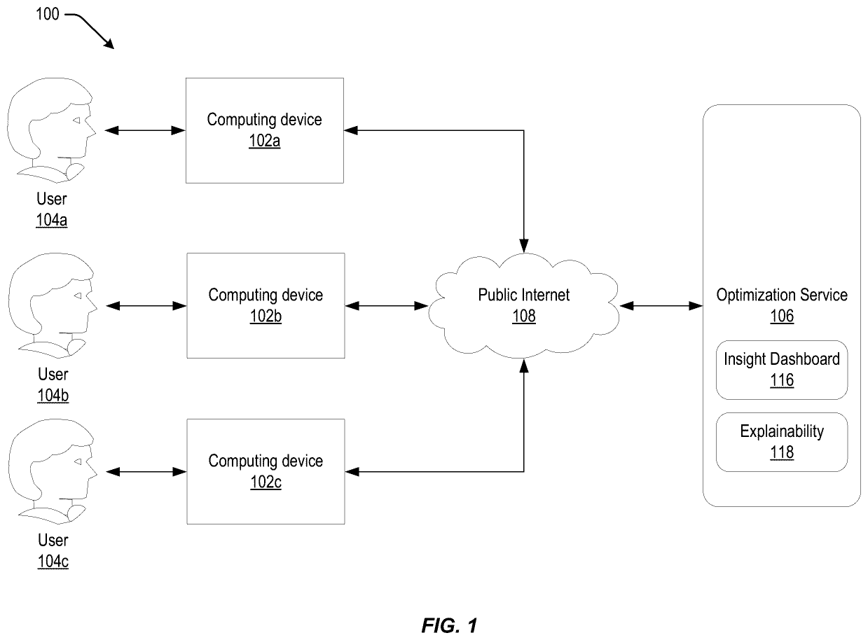

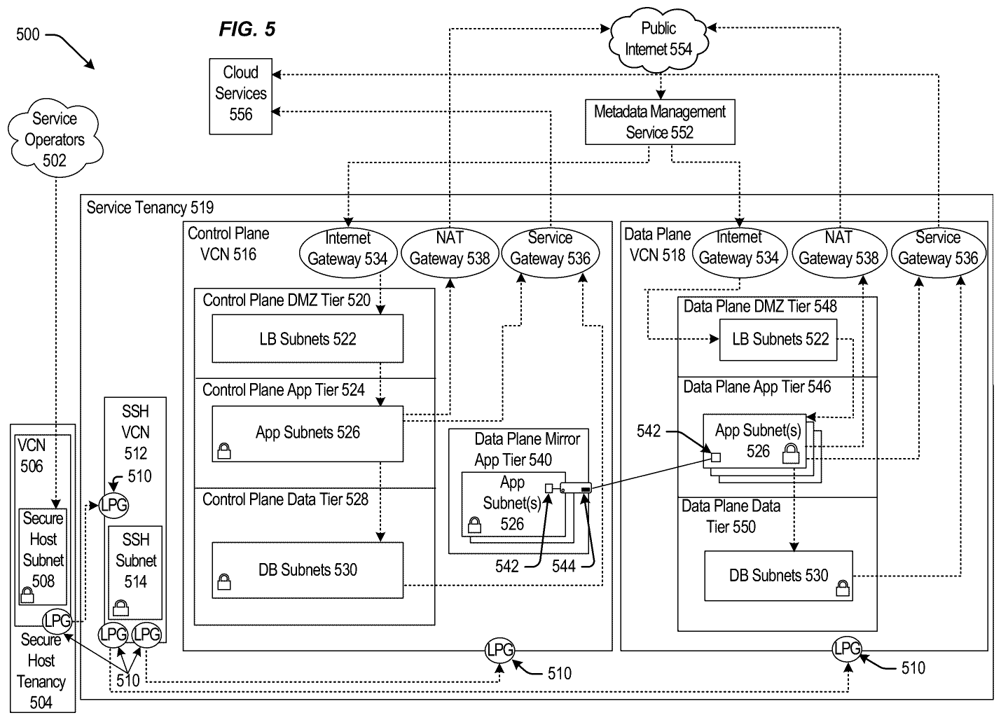

Referring to FIG. 1, an infrastructure as a service (IaaS) system 100 is depicted. The IaaS system 100 can include any combination of hardware and software to implement the present disclosure. For example, the system 100 can be part of or otherwise include cloud computing infrastructure. The system 100 includes a plurality of computing devices 102a, 102b, 102c accessible by a plurality of users 104a, 104b, 104c. The plurality of computing devices 102a, 102b, 102c can include any combination of computing devices, for example, client computing devices as discussed with respect to FIG. 5. In some embodiments, the system 100 includes an optimization service 106 accessible by the plurality of computing devices 102a, 102b, 102c, for example, through a public internet 108 or other communication medium.

In some embodiments, the optimization service 106 is a combination of hardware and software provided part of an infrastructure as a service (IaaS) this can be configured to carry out optimization services for operations research. The optimization service 106 can include any combination of systems and methods configured to provide analytical methods to improve decision making solutions for real-world problems using a combination of modeling, statistics, and optimization. For example, the operations research can provide extreme values (e.g., min, max) of some real-world objective to the maximize profit, performance, yield, etc. or minimize loss, risk, cost, etc. In some embodiments, the optimization service 106 be or otherwise include a Representational state transfer (REST) architecture to provide an interface between the computing devices 102a, 102b, 102c and the IaaS systems providing the operations research. Any combination of interfaces can be used to communication and/or exchange data with the computing devices 102a, 102b, 102c and the IaaS systems and is not intended to be limited to REST.

In some embodiments, the optimization service 106 can include an insight dashboard 116 and an expandability 118. The insight dashboard 116 can provide a graphical user interface accessible by or rendered by the computing devices 102a, 102b, 102c to convey information to the users 104a, 104b, 104c of the computing devices 102a, 102b, 102c. Using the insight dashboard 116, the users 104a, 104b, 104c can use computing devices 102a, 102b, 102c to communicate with the optimization service 106 to provide data related to one or more problems to be mathematically solved and delivered back to the users 104a, 104b, 104c via the insight dashboard 116. The users 104a, 104b, 104c can use the insight dashboard 116 to access the optimization service 106 to solve different types of problems and having different types of use cases. For example, user 102a can have a problem(s) related to procurement, user 102b can have a problem(s) related to scheduling optimization, and user 102c can have a problem(s) related to inventory optimization. In an inventory optimization example, the problem can be related to a single inventory optimization in which a user or entity wants to order goods from single source. The constraints for the inventory optimization problem could include shipment time and the object function may want to maximize revenue to meet customer demand given shipping constraints and other decision variables (e.g., shipping costs, goods costs, etc.). An example of an operation research problem can be presented by the below formulation.

$$\begin{matrix}min & f ( {x}_{1} , {x}_{2} , … , {x}_{n} ) & & ( objective function ) \\ s . t . & {g}_{i} ( {x}_{1} , {x}_{2} , … , {x}_{n} ) \leq {b}_{i} & ∀ i = 1 , … , m & ( constraints ) \\ & {x}_{j} ∈ ℝ & ∀ j = 1 , … , n . & ( decision variable )\end{matrix}$$

As shown above, an operation research problem can include an object function, one or more constraints, and one or more decision variables. While the problems are different, they may each have similar categories of parameters. For example, each problem can include an objective function, various constraints, and decision variables. The goal of operation research is to optimize the object function (e.g., minimize or maximize), while satisfying the object constraints, using the parameter decision variables provided. Operation research can be used to solve problems for different verticals (e.g., vertical integration, sales vertical, vertical market, etc.) that a user or entity is optimized. A given vertical defines a group of similar use-cases. For example, supply chain optimization and scheduling optimization belong to two different verticals, while a vertical like scheduling optimization may have many similar use-cases, such as nursing optimization, call-center optimization and etc.

In typical procurement problems, a buyer may be seeking a selection of suppliers and release purchase orders for different items in such a way that certain business constraints are satisfied while optimizing certain business objectives such as minimization of procurement cost, maximization of supplier score or maximization of award quantity or combination of multiple objectives. Such problems are categorized as award optimization or sourcing optimization problems and can be formulated as a linear programing (LP) problem. In typical scheduling optimization problem, recommending specific order of actions, such as the order of addressing incoming service requests so that a business goal such as minimizing queue time is achieved, can be sought. Whereas, in call centers, one of the decisions being made may be the allocation of specific number of agents to queues/hives. Such problems are categorized as a scheduling problem and can be formulated as a constrain problem. In typical inventory optimization problem, the main goal may be to find an inventory policy which minimize costs or maximize profits while keeping optimal balance among the service level, savings, and costs. Such problems are categorized as a supply chain optimization problem and can be formulated as mixed integer programming and dynamical programming problems. The optimization service 106 can be configured to exchange feedback with the users 104a, 104b, 104c regardless of the type of problem being solved or the parameters associated therewith. The explainability 118 can be used to deliver the solutions generated by the IaaS to the computing devices 102a, 102b, 102c in a manner that is understandable by the users 104a, 104b, 104c.

In the traditional approaches, the sensitivity analysis, which is needed for explainability, is not always possible. Such analysis is based on what-if scenarios which becomes computationally expensive as number of variables grow. However, in the present disclosure, the explainability is computationally affordable. The explainability are generated by a reinforcement learning (RL) agent by computing various metrics while performing the optimization utilizing all historical and simulated data already obtained in the previous steps of learning and already saved in a database. Therefore, in the present disclosure effectively exploits the existing data accumulated in the previous steps of learning such that there is no need to recompute all what-if scenarios for the explainability.

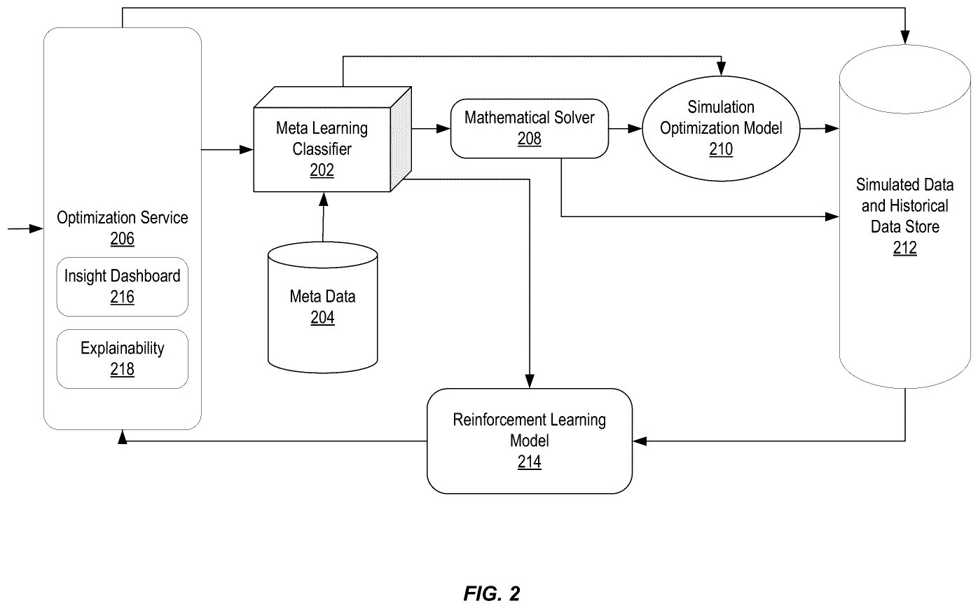

Referring to FIG. 2, an infrastructure as a service (IaaS) system 200 is depicted. The system 200 combines multiple models into an agnostic framework to accommodate any combination of use cases within any combination of verticals while providing different solutions to minimize computational resources. In some embodiments, the system 200 can include an optimization service 206, a meta learning classifier 202, a mathematical solver 208, a simulation optimization model 210, a simulated data and historical data store 212, and a reinforcement learning model 214.

The optimization service 206 can include an insight dashboard 216 and an expandability 218, for example, as discussed with respect to the optimization service 106 of FIG. 1. The optimization service 206 can be configured to receive a payload from a computing device (e.g., one of the computing devices 102a, 102b, 102c) and process the payload for use within the system 200. In some embodiments, a customer can provide a standardized payload that is generic and can be used for all use-cases. In some embodiments, the payload can be a template with required data for different use-cases. For example, a given constrain on variable can be defined in the payload j son file with a pre-defined expression that the model(s) within the system 200 can understand. The j son file can include a bunch of dictionary, key-value items. For a given use-case, the naming of the use-case maps to a key with its values corresponding to a sub-dictionary with all parameters of a given use-case. In some embodiments, the payload can create a contract with the system 200 passing all required parameters.

In some embodiments, the meta learning classifier 202 can require two types of data including the payload data which gives customized data for a given use-case and meta data which describes properties of different OR use-cases and historical data if those problem can be solved by any of the solvers (given some KPIs or metrics). The payload data can be provided by the customer while the meta data can be available for all use-cases and customers. In some embodiments, these two types of data can be used to train the meta learning classifier 202. In some embodiments, the optimization service 206 can validate the payload and does some preprocessing by imputing the data and converting the data to the right format and type if needed.

In some embodiments, the payload can be processed to transform the received data into a format that is readable and useable by the meta learning classifier 202. For example, the optimization service 206 can process the received payload in a format that can be used for classifying by the meta learning classifier 202. In some embodiments, the payload can include a problem and one or more descriptors of features to describe use case characteristics for the problem.

For example, the lead time in the supply chain management problem, can be deterministic or stochastic. This mainly determines whether the problem can be solved by the mixed-integer programming or requires simulation based optimization. In the payload, as a descriptor, the user provides the value of lead time. For example, with a deterministic lead-time, the user would provide a descriptor including:

```
{“Supply-chain problem”: [
  {{“lead-time”: deterministic,
  {“value”: 1 week}},
  ....
]
```

In another example, with stochastic a lead-time, the user would provide a descriptor including:

```
{“Supply-chain problem”: [
  {{“lead-time”: stochastic ,
  {“value”: normal-distribution},
  {“mean”: 3},
  {“uncertainty”: 1}},
....
]
```

The descriptor of the lead-time and other features are passed to the meta learning classifier 202 and the model can determine the class of the problem and its corresponding solver (mathematical solver 208, simulation optimization model 210, etc.). In some embodiments, the data related to the problem can include an objective function, one or more constraints, and one or more decision variables. The problem can also be related to a vertical and one or more use cases for that vertical. The processing can include extracting and/or extrapolating data from the problem and/or use cases. Thereafter, the processed data can be provided to other components within the system 200 for additional processing.

In some embodiments, the optimization service 206 provides the processed payload to the simulated data and historical data store 212 and to the meta learning classifier 202 for classification for analysis by one or more of the mathematical solvers 208, the simulation optimization model 210, and the reinforcement learning model 214. The meta learning classifier 202 can be an automatic learning algorithm that is applied to metadata, for example, stored in meta data 204. In some embodiments, initially, the meta data can be created manually by data annotators with domain expertise and later the meta data can be updated using the historical solutions obtained by the optimization service 206. For example, the meta data can be updated by the optimization service 206 and stored in a database (e.g., database 212) as tabular data with a pre-defined schema. The meta data can include a collection of historical data that describes properties of different operation research use-cases and historical data for solving different problems. The meta data can also include data that indicated which problems can be or historically have been solved by any of the mathematical solver 208, the simulation optimization model 210, and the reinforcement learning model 214, given some Key Performance Indicators (KPIs) or metrics. The meta data can be updated on regular bases using historical solutions obtained by the optimization service 206 itself and other sources. In some embodiments, when the optimization service 206 is deployed, the meta data can also be created and stored in the database as a part of the deployment pipeline before building the model for the meta learning classifier 202. For example, the meta learning classifier 202 can apply the meta data into a meta learning model to classify problems by determining what type(s) of problem is being solved.

In some embodiments, the meta learning classifier 202 can use a prediction model to predict which of the mathematical solver 208, the simulation optimization model 210, and the reinforcement learning model 214 is best suited to solve the problem based on the data provided. The prediction can be made with a percentage chance or confidence score that the prediction is correct. The prediction can include assigning a percentage value to each of the mathematical solver 208, the simulation optimization model 210, and the reinforcement learning model 214 that the meta learning classifier 202 determines the likelihood that each of the mathematical solver 208, the simulation optimization model 210, and the reinforcement learning model 214 can solve the given problem. In some embodiments, the meta learning classifier 202 can trained using the meta data and can implement ensemble learning using multiple learning algorithms to obtain better predictive performance.

To perform the prediction, the meta learning classifier 202 checks the object function, constraints, and decision variables, for the problem and characteristics of the use-case data and feature descriptors to determine the probability that the problem can be solved by the mathematical solver 208, the simulation optimization model 210, and the reinforcement learning model 214. Depending on the nature of the object function, constraints, and decision variables the meta learning classifier 202 can parse meta data to determine how to best solve the problem. In some embodiments, the meta learning classifier 202 can check the characteristics of the use-case data and feature descriptors to determine whether the data is integer or non-integer, whether the parameters are deterministic or stochastic.

Each characteristic can be associated with one or more types of problem solving. For example, if the characteristics indicate that the payload includes deterministic data that can be solved by one or linear programming (LP), mixed integer programming (MIP), or non-linear programing (NLP), then the meta learning classifier 202 can determine that the problem can be solved by the mathematical solver 208. If the characteristics indicate that the payload includes stochastic data or that it cannot be solved by one or linear programming (LP), mixed integer programming (MIP), or non-linear programing (NLP), then the meta learning classifier 202 can determine that the problem can be solved by simulation optimization model 210 and/or the reinforcement learning model 214. For example, if the payload has a feature “lead-time” and its value is either “deterministic” or “Stochastic”, the meta learning classifier 202 model can first vectorize these two values, mapping it to 0 or 1. Then using this data, the meta learning classifier 202 can assign 0 to exact solver and 1 to simulation.

In some embodiments, based on the analysis of the characteristics of the payload, a prediction value can be assigned by the meta learning classifier 202 to each of the mathematical solver 208, the simulation optimization model 210, and the reinforcement learning model 214 and can range from 0%-100% probability. Any combination of classification models can be used to provide the probability of classes.

The meta learning classifier 202 can also determine the type of programing to be implemented based on the type of data being used. For example, integer data can be associated with linear programing or mixed integer programing while non-integer data can be associated with linear programing if constraints are all linear or non-linear programing if constraints are non-linear constraints. The types of data can be determined by the meta learning classifier 202 of by the optimization service 206 pre-processing using combination of method. For example, the linear data structures can be identified as data types that are arranged in an orderly manner, while non-linear data structures can be identified as data types that are arranged in a sorted order, creating a relationship among data elements. The meta learning classifier 202 can determine whether the problem should be solved by one of linear programming (LP), mixed integer programming (MIP), or non-linear programing (NLP) based on the payload data. Using the above formulation as an example, reproduced below, the meta learning classifier 202 can make a prediction based on how the characteristics are viewed.

$$\begin{matrix}min & f ( {x}_{1} , {x}_{2} , … , {x}_{n} ) & & ( objective function ) \\ s . t . & {g}_{i} ( {x}_{1} , {x}_{2} , … , {x}_{n} ) \leq {b}_{i} & ∀ i = 1 , … , m & ( constraints ) \\ & {x}_{j} ∈ ℝ & ∀ j = 1 , … , n . & ( decision variable )\end{matrix}$$

For example, if deterministic, the above formulation can be solved through linear programing if the ƒ and gi functions are all linear in x. However, if at least one of ƒ and gi is nonlinear in x, then it can be non-linear programming. A solution vector xi is obtained by iteratively minimizing the objective function evaluation. If any decision variables xi become stochastic or not more constant, then the linear programing or mixed integer programing solvers becomes useless and the solutions requires a new method (e.g., simulation or reinforcement learning).

In summary, the meta learning classifier 202 predicts, based on the payload and meta data, which describes a particular use-case of operation research problems that can be solved in one or more of the target models of linear programming (LP), mixed integer programming (MIP), non-linear programing (NLP), simulation, or reinforcement learning. Once the problem being solved is determined, the meta learning classifier 202 can label the payload for the appropriate target model and provide the problem to the appropriate program, application, or model for solving that problem type. For example, if variables are deterministic the meta learning classifier 202 can label the payload for the mathematical solver 208 and if variables are stochastic then the meta learning classifier 202 can label the payload for the simulation optimization model 210.

The meta learning classifier 202 can send data to one or more of the programs or models to solve the problem based on the probability. For example, if the meta learning classifier 202 determines a probability for solving the problem is 50% at the mathematical solver 208 and 50% at the simulation optimization model 210, then the meta learning classifier 202 will provide the payload to both. In contrast, if the probability heavily favors one of the models, the meta learning classifier 202 will only provide the payload to that model. For example, if the meta learning classifier 202 determines a probability for solving the problem is 90% at the mathematical solver 208, then the meta learning classifier 202 will just send the payload to mathematical solver 208.

The mathematical solver 208 can be configured to receive payload data from the meta learning classifier 202 and process the payload using one or more algorithms or models. In some embodiments, the mathematical solver 208 can be configured to process the payload using one or more of linear programming, mixed integer programming, and non-linear programming to find the optimal solution for the problem provided within the payload. The mathematical solver 208 can implement any number of programs or models for solving deterministic problems. For example, the mathematical solver 208 can include a combination of a COIN-OR branch and cut (CBC), SCIP, and GNU Linear Programming Kit (GLPK) solvers. The mathematical solver 208 can determine which of the models to use based on an analysis of the payload. For example, the payload can be provided with one or more labels, assigned by the meta learning classifier 202. In another example, the mathematical solver 208 can determine the best model to use based on its own analysis of the payload. In some embodiments, the meta learning classifier 202 translates the payload into internal data structure including a script encoded into a specific language that can be fed to mathematical solver 208 to be solved along with data file.

If and when the mathematical solver 208 has solved the problem within the payload, the optimal solution can be provided to the simulated data and historical data store 212 for future reference by one or more models within the system 200. The mathematical solver 208 can transmit the payload along with the solutions to the simulated data and historical data store 212. The mathematical solver 208 can format the data in a manner which can be accessed by the optimization service 206 (e.g., via service API request) to provide a result to a user for viewing and as part of set of training data for use by other components, for example, the reinforcement learning model 214.

The simulation optimization model 210 can be configured to receive payload data from the meta learning classifier 202 and process the payload using one or more algorithms or models. In some embodiments, the simulation optimization model 210 can be configured to process the payload using one or more of simulation programs to find the optimal solution for the problem provided within the payload. The simulation optimization model 210 can implement any number of simulation methods for numerically solving non-deterministic or stochastic problems or problems that cannot be solved via LP, MIP or NLP. For example, the simulation optimization model 210 can include a combination of a stochastic programing, Monte Carlo simulation, and discrete event simulation. The simulation optimization model 210 can determine which simulations to use based on an analysis of the payload. For example, the payload can be provided with one or more labels, assigned by the meta learning classifier 202. In another example, the simulation optimization model 210 can determine the best simulation methods to use based on its own analysis of the payload. In some embodiments, the meta learning classifier 202 translates the payload into internal data structure including a script encoded into a specific language that can be fed to simulation optimization model 210 to be solved along with data file.

If and when the simulation optimization model 210 has solved the problem within the payload, the optimal solution can be provided to the simulated data and historical data store 212 for future reference by one or more models within the system 200. In some embodiments, the simulation optimization model 210 can run the simulation with all reasonable values of parameters to create what if scenarios using variable parameters, which can be used to create a set of data for use in training reinforcement learner and find an optimized solution using optimization random search or stochastic gradient descent. The simulation optimization model 210 can transmit the payload along with the optimized and non-optimized solutions to the simulated data and historical data store 212. The simulation optimization model 210 can format the data in a manner which can be accessed by the optimization service 206 (e.g., via service API request) to provide a result to a user for viewing and as part of set of training data for use by other components. Since the simulations being run by the simulation optimization model 210 may take a significant time to be completed, the optimization service 206 can implement an asynchronous REST API for training and an inference where the REST endpoints send the request to the simulated data and historical data store 212, independent from the other models. In some embodiments, the results provided by the simulation optimization model 210 can be used to build a data set of what if scenarios for the explainability 218 and data for training the reinforcement learning model 214.

The data provided to the simulated data and historical data store 212 by the mathematical solver 208 and simulation optimization model 210 can include solved problem data and unsolvable problem data. For example, the mathematical solver 208 and simulation optimization model 210 can store the provided meta data and feature descriptors, noting whether a solution was identified, and providing the optimal solution, if any. In stances where the mathematical solver 208 or simulation optimization model 210 cannot identify an optimal solution, the failed solution can also be provided to the simulated data and historical data store 212. The failed solution can include information about the payload, the models run, and why the model failed to find an optimal solution (e.g., calculating error, runtime error, improper data values, insufficient information, formatting issues, computational limitations, etc.). The combination of solved and unsolved data can be used to train one or more of the models within the system 200. For example, the reinforcement learning model 214 can use the combination of solved and unsolved data to identify a solution to the problem by identifying a problem (also saved in the simulated data and historical data store 212) that shares similar meta data and feature descriptors but has a solution associated therewith.

In some embodiments, the mathematical solver 208 and simulation optimization model 210 can hand off a payload to other models if they are unable to solve the problem or it is determined that the problem was misclassified (e.g., better suited for a different model). The decision to hand off payload data to another model can be determined by the model itself or through an instruction received from the meta learning classifier 202. For example, mathematical solver 208 can determine that stochastic problem solving is needed, then the mathematical solver 208 can send payload to simulation optimization model 210 for solving. In some instances, to save computational resources, the meta learning classifier 202 can only designate which model receive the payload before and after the models process the payload. For example, if the meta learning classifier 202 determines with high probability (e.g., greater than 80%) that the mathematical solver 208 is appropriate, and the mathematical solver 208 fails to solve the problem, then the payload data including the unsolved status will be provided to the simulated data and historical data store 212. Limiting the number of models processing the payload can be provided for efficiency and to avoid blind trial and error.

The reinforcement learning model 214 can be configured to receive payload data from the meta learning classifier 202 and process the payload using deep reinforcement learning and the data stored in the simulated data and historical data store 212. Using the simulated data and historical data store 212, the reinforcement learning model 214 can access results from each of the mathematical solver 208 and the simulation optimization model 210 as well as the original meta data received by the meta learning classifier 202.

In some embodiments, the reinforcement learning model 214 can have two components, including an agent and a simulation. The simulation is provided by the simulated data from the simulation optimization model 210 and the agent can try to make sense of the data. For example, the agent can check multiple events derived from the simulated data. In some embodiments, the events can be derived by varying the initial parameters of the problem, which can be automated using reinforcement learning. Thereafter, each event can be translated into a cascade of an action, a state, and a reward. The action can be the solution of problem, the state can be the parameters of the problem, and the reward is the actual metric or KPI whether the solution is acceptable or not.

In some embodiments, if the meta learning classifier 202 indicates that the problem needs continuous action space, an alternative approach for modeling the agent can be used. The determination can be provided by the descriptor or features of the problem in the payload. For example, for the award allocation, a feature can be included to indicate the type of award and if this is not an integer then the meta learning classifier 202 can determine that it is dealing with continuous actions. The alternative approach for modeling the agent can include any combination of models. For example, a Deep Deterministic Policy Gradient (DDPG) model can be used. The DDGP can learns a Q-function, to compute a Q value for quality of the actions based on the state to provide result, and a policy using off-policy data. To reduce the variance further, and to build an effective and efficient reinforcement learning, the reinforcement learning model 214 can use both PPO and DDPG in parallel using ensemble-learning techniques updating a global value function in an asynchronous way.

The reinforcement learning model 214 can implement a stochastic policy gradient method, such as Proximal Policy Optimization (PPO) that has been extended to operate in off-policy mode using experience replay mechanism. In off-policy mode, the agent can learn using exploration of the simulated data and historical data store 212. A policy, in reinforcement learning (RL), is a mapping from space of state to space of actions. The policy can be imagined to be a series of instructions for the reinforcement learning model 214 agent, in terms of what actions it should take, given state of the environment it is currently in or observing. In some embodiments, the reinforcement learning model 214 can use the Actor-Critic Model for the PPO implementation that use two Deep Neural Networks that works together. One of the Deep Neural Networks can take the action (actor) and the Deep Neural Network can handle the corresponding rewards (critic).

In some embodiments, the reinforcement learning model 214 can search for patterns within all of the input data, the results from the mathematical solver 208 and the simulation optimization model 210 using that data, and all historical data related to the input data, optimal solutions, failed solutions, etc. Based on the pattern search, the reinforcement learning model 214 can come up with a same solution as one of the mathematical solver 208 and the simulation optimization model 210, a better solution than the mathematical solver 208 and the simulation optimization model 210, or a new solution when one was not reached by either of the mathematical solver 208 and the simulation optimization model 210. In some embodiments, the results of the reinforcement learning model 214 optimizer is compared with the solutions obtained from the mathematical solver 208 and the simulation optimization model 210, for given a metric, and then the reinforcement learning model 214 agent decides which solution should be sent to the front-end user. The metric can include any combination of data useful in determining which solution is best. For example, for the case of supply chain problem, the metric can be the total cost of the system (including holding and shortage costs) and for use of scheduling problems, the metric can be the average time of queue or resolution, or the total cost of agent. The metric can be any combination of user defined or computer derived (e.g., using AI). The metric can be, for example, the computed objective score in different approaches.

In the event that no optimal solution exists within the feasible region, the reinforcement learning model 214 can provide an approximate solution which may satisfy most of the constrains and at the same time gives the best value for the objective function. The approximate solution can be based on a combination of factors. For example, the approximate solution can be based on a history of the evaluation of the metric, and the required latency imposed due to the computation resources. The reinforcement learning model 214 can determine the best solution given history of actions taken by the reinforcement learning model 214.

In some embodiments, the reinforcement learning model 214 can double check work of the mathematical solver 208 and the simulation optimization model 210 to perform a validation to determine if solution is sufficient. The validation can include any combination of methods. For example, given the evaluated metrics and parameters of the problem(s), the reinforcement learning model 214 can compare its own solutions with other existing ones and make the best decision based on the comparison. In some embodiments, the reinforcement learning model 214 performs a debias to the solutions via a propensity score or an off-policy evaluation method. The final optimized results should be then added to the simulated data and historical data store 212 and the reinforcement learning model 214 can use these new data points (optimized solutions) in the next round of training to learn to make better decisions. This feedback loop is crucial for improving the model in the production.

In some embodiments, the reinforcement learning model 214 can be trained using all the historical data provided by the mathematical solver 208 and the simulation optimization model 210 and stored in the simulated data and historical data store 212. The reinforcement learning model 214 can be trained using offline training by relying on the simulations run by the simulation optimization model 210 which included all reasonable values of parameters using variable parameters such that there is not necessarily an explicit need for the reinforcement learning model 214 to perform any simulation training on its own. Instead, the reinforcement learning model 214 uses the optimization simulation data from the simulation optimization model 210. This configuration provides an advantageous approach that is data-driven offline learning for the reinforcement learning model 214 agent. While the reinforcement learning model 214 algorithms can learn directly through trial and error in the real world, such online interaction may be impractical for safety-critical or cost-critical problems, such as problems in the operation research.

If and when the reinforcement learning model 214 has solved the problem within the payload, the optimal solution can be provided to the simulated data and historical data store 212 for future reference by one or more models within the system 200. The reinforcement learning model 214 can transmit the payload along with the solutions to the simulated data and historical data store 212. The reinforcement learning model 214 can also provide the optimal solution to the optimization service 206 for viewing. In some embodiments, the reinforcement learning model 214 can format the data in a manner which can be accessed by the optimization service 206 (e.g., via service API request) to provide a result to a user for viewing and as part of set of training data for use by other components, for example, the reinforcement learning model 214.

In some embodiments, the data needed for the insight dashboard 216 and the explainability 218 can be generated by the reinforcement learning model 214 agent by computing various metrics while performing the optimization utilizing all historical and simulated data already obtained. The insight dashboard 216 and the explainability 218 can include data based on the results of the system 200. For example, the data can include providing indications for changing the parameters of the problem to build what-if scenarios. The explainability is computationally affordable and it is by-product of the approach. The explainability can be generated by the reinforcement learning model 214 by computing various metrics while performing the optimization utilizing all historical and simulated data already obtained in the previous steps of learning and already saved in the data store 212. The reinforcement learning model 214 can effectively exploit the existing data accumulated in the previous steps of learning and in this way there is no need to recompute all what-if scenarios for the explainability. The various metrics can include any combination of data that is desirable for a user. For example, for the supply chain problem, the useful metrics are the total cost of the system and the Service Level. These metrics can be obtained by changing the parameters of the problem (the state of the reinforcement learning model 214). The best solution can be provided to the optimization service 206 for user acceptance or denial. The optimization service 206 can receive the feedback from the user to be stored in the simulated data and historical data store 212 for improving the reinforcement learning model 214.

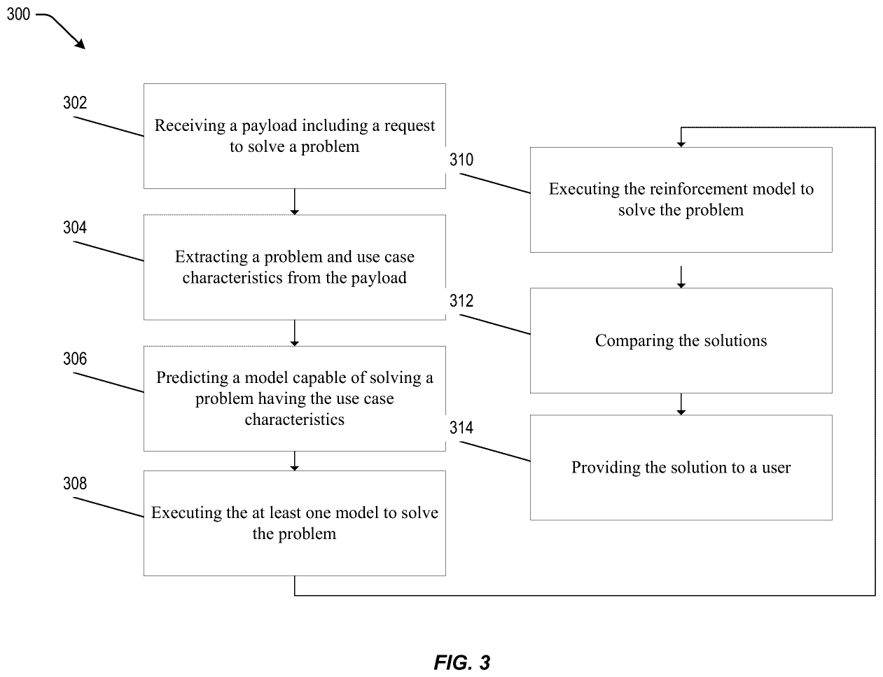

Referring to FIG. 3, a flowchart depicting a processes 300 implementing the system 200, in accordance with the present disclosure, is depicted. At step 302, an optimization service 206 receives a payload from a user 104a, 104b, 104c, for example, via one of the computing devices 102a, 102b, 102c. The payload can include a problem related to operation research for one or more verticals having one or more use cases. The optimization service 206 can perform any pre-processing and provide the payload to the meta learning classifier 202.

At step 304, the meta learning classifier 202 inspects the payload to extract data necessary for making a prediction for a model to solve the problem identified in the payload. For example, the meta learning classifier 202 can extract the problem including an object function, constraints, decision variables, use case characteristics, descriptors of features, meta data, etc. This data can be obtained from the payload and the meta data (available in the data store 212).

At step 306, the meta learning classifier 202 predicts one or more models (e.g., the mathematical solver 208 and the simulation optimization model 210, the reinforcement learner 214) capable of providing a solution to the problem using the use case characteristics. Thereafter, the meta learning classifier 202 provides the payload to the appropriate one or more models.

At step 308, the predicted one or more models can receive the payload and attempt to solve the problem. If an optimal solution is reached the model will provide the solution to the simulated data and historical data store 212. If an optimal solution is not reached, the model will indicate that a solution was not found and save that in the simulated data and historical data store 212.

At step 310, the reinforcement learner 214 receives the payload and attempts to solve the problem. If an optimal solution is reached the reinforcement learner 214 will provide the solution to the simulated data and historical data store 212. If an optimal solution is not reached, the reinforcement learner 214 will provide the best predicted solution and save it in the simulated data and historical data store 212.

At step 312, the reinforcement learner 214 compares the solution provided by the one or more models to the solution determined by the reinforcement learner 214. The reinforcement learner 214 will determine which solution is the optimal solution based on the comparison. The comparison can validate the solution provided by one of the other models or the reinforcement learner 214 can use its own solution to replace the solutions provided by the other models.

At step 314, the optimization service 206 receives optimal solution from the reinforcement learner 214 to be displayed to a user for feedback.

While the operations of processes 300 and 400 are described as being performed by generic computers, it should be understood that any suitable device may be used to perform one or more operations of this process. Process 300 (described above) and process 400 (described below) are illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform functions or implement data types. The order in which the operations are described is not intended to be construed as a limitation, and any number of the described operations can be combined in any order and/or in parallel to implement the processes

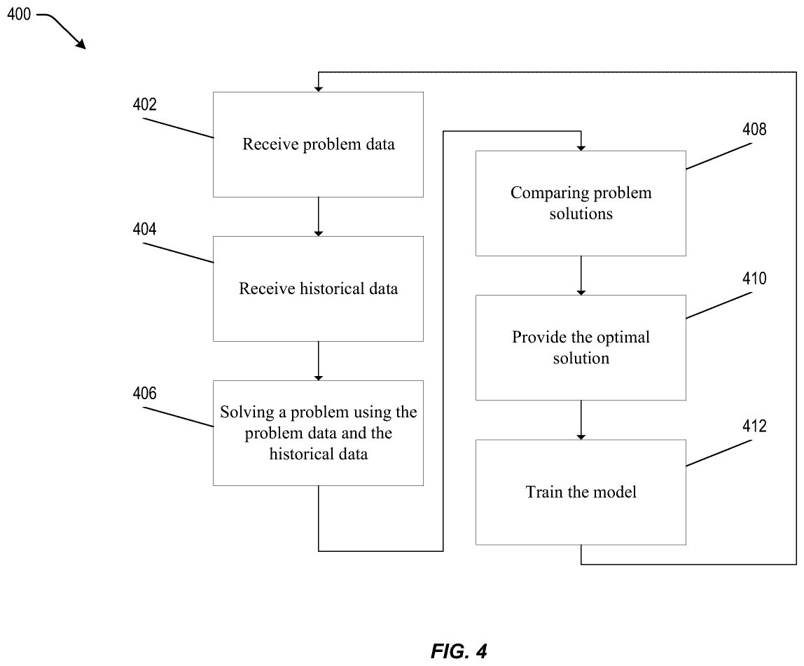

Referring to FIG. 4, a flowchart depicting a process 400 implementing the reinforcement learning model 214, in accordance with the present disclosure, is depicted. At step 402, the reinforcement learning model 214 receives a payload from a user 104a, 104b, 104c, for example, via the meta learning classifier 202. The payload can include a problem related to operation research for one or more verticals having one or more use cases. The reinforcement learning model 214 can receive the payload in the same pre-processed form as received by the meta learning classifier 202 or the payload can be further processed by the meta learning classifier 202.

At step 404, the reinforcement learning model 214 receives historical data from the simulated data and historical data store 212. The historical data received by the reinforcement learning model 214 can include any combination of data that assists the reinforcement learning model 214 in finding a solution for the problem within the payload. For example, the reinforcement learning model 214 can receive past solutions for problems that have been identified as being similar to the problem from the payload. The past solutions can include any combination of solutions derived by any combination of the mathematical solver 208, the simulation optimization model 210, and the reinforcement learning model 214 itself. The historical data can also include any combination of data associated with the previous solutions, previous problems, meta data, and/or other parameters used to determine the solutions.

At step 406, using the problem data and the historical data, the reinforcement learning model 214 derives a solution to the problem within the payload. In some embodiments, reinforcement learning model 214 processes the payload using deep reinforcement learning and the data stored in the simulated data and historical data store 212.

At step 408, once the reinforcement learning model 214 has derived its own solution to the problem within the payload, it compares the solution to other solutions to the problem derived by other models within the system 200. For example, using the simulated data and historical data store 212, the reinforcement learning model 214 can access results from each of the mathematical solver 208 and the simulation optimization model 210, then perform a comparison of the results. In some embodiments, the reinforcement learning model 214 can search for patterns within all of the input data, the results from the mathematical solver 208 and the simulation optimization model 210 using that data, and all historical data related to the input data, optimal solutions, failed solutions, etc.

At step 410, the reinforcement learning model 214 provides the optimal solution to the user. For example, the reinforcement learning model 214 agent decides which solution is the best solution (e.g., based on the comparison of step 408) and provides the solution to the front-end user. In some embodiments, the reinforcement learning model 214 the also provides the best solution to the simulated data and historical data store 212. The solution can also be provided with additional context, for example, why it was selected over solutions derived by one or more of the mathematical solver 208 and the simulation optimization model 210. Even if the best solution isn't an optimal solution, the reinforcement learning model 214 may still provide the solution to the user.

At step 412, the reinforcement learning model 214 is trained using a combination of data, including the selected best solution. For example, the final optimized results are added to the simulated data and historical data store 212 and the reinforcement learning model 214 can use these new data points (optimized solutions) in the next round of training, as part of a feedback loop, to learn to make better decisions. In some embodiments, the reinforcement learning model 214 can be trained using all the historical data provided by the mathematical solver 208 and the simulation optimization model 210 and stored in the simulated data and historical data store 212.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. However, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

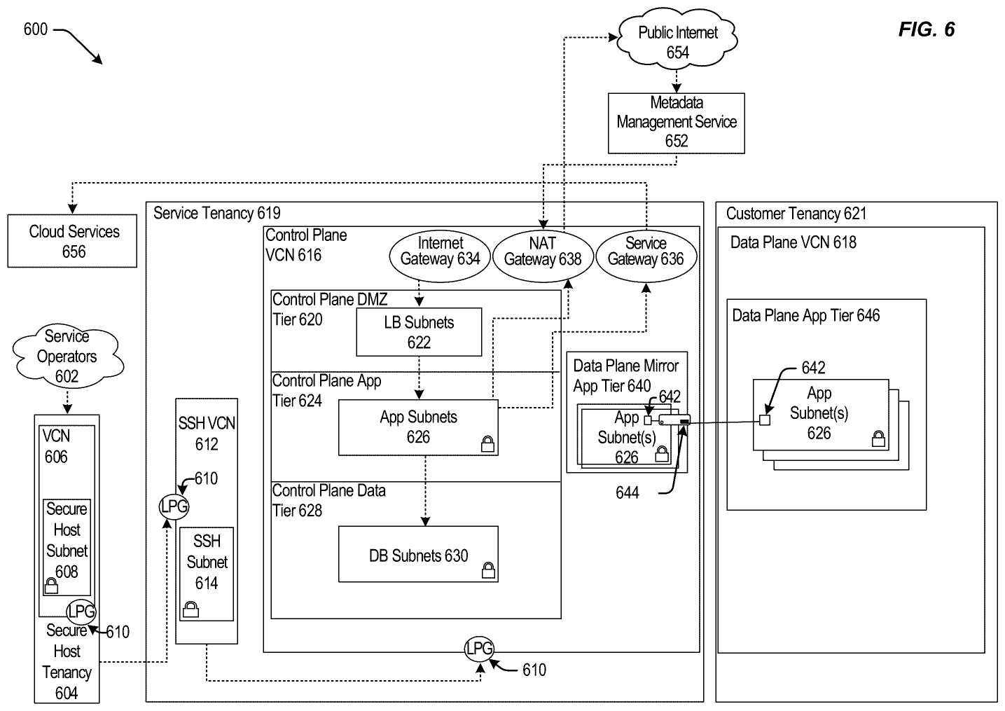

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively couple to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

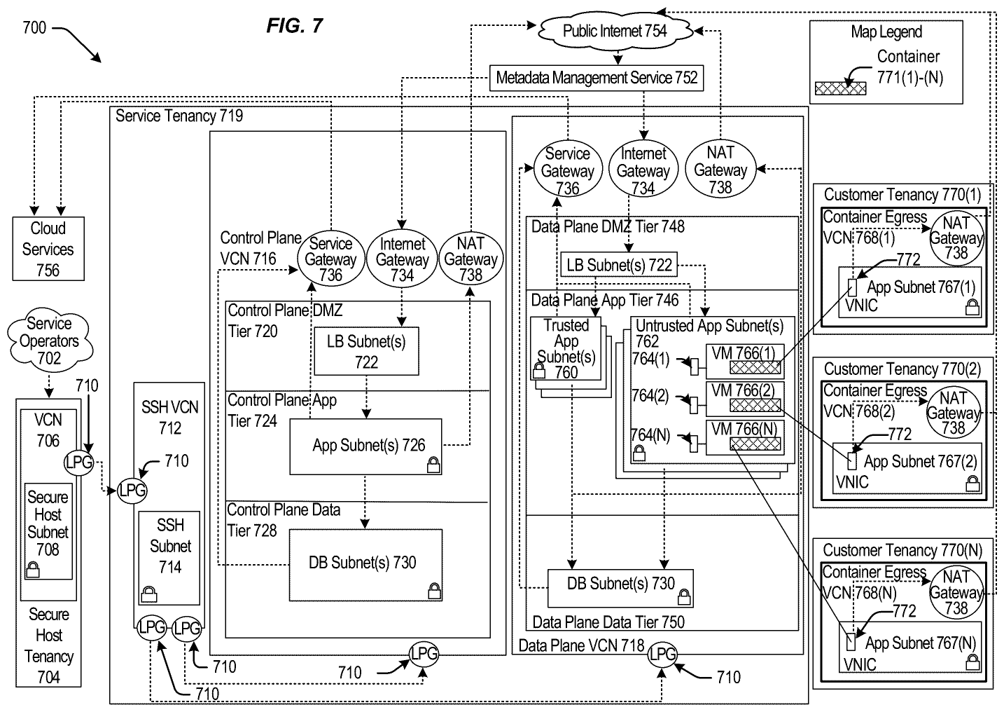

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively couple to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

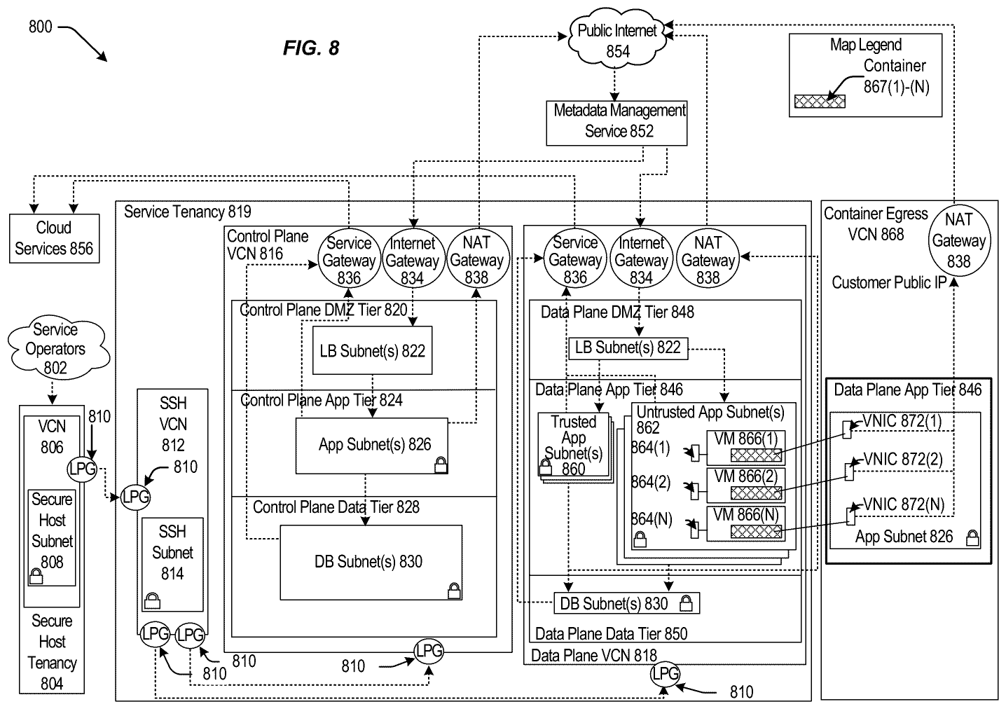

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

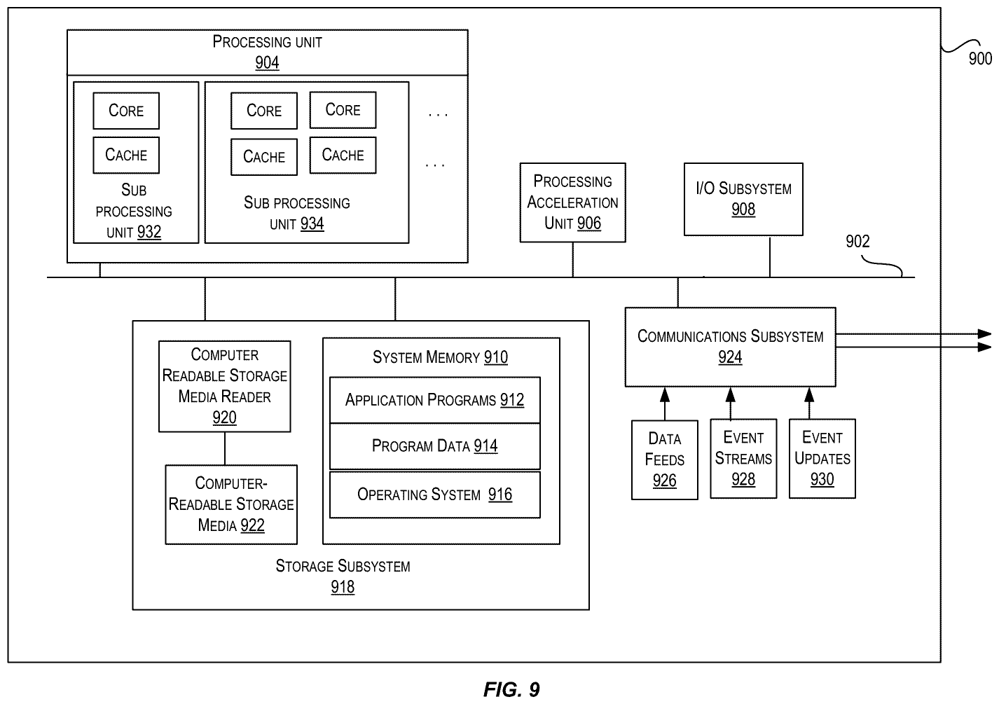

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with the present disclosure.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, at a data processing system, a payload including a request for optimizing a service;
processing, by the data processing system, the payload, using a meta learning classifier, the processing comprising:
extracting a problem and use case characteristics from the payload;
predicting at least one machine learning model capable of solving the problem having the use case characteristics; and
executing the at least one machine learning model to solve the problem;
outputting, by the data processing system, a solution to the problem for optimizing the service from the at least one machine learning model; and
providing, by the data processing system, the solution to a computing device.

2. The method of claim 1, wherein the at least one machine learning model comprise one of a mathematical solver, a simulation optimization model, and a reinforcement learning model.

3. The method of claim 2, wherein:
the mathematical solver includes programs capable of solving a combination of a linear programming (LP), non-linear programming (NPL), and mixed integer programming (MIP);
the simulation optimization model includes programs capable of performing stochastic programming, a Monte Carlo simulation, and a discrete event simulation; and
the reinforcement learning model includes a neural network or a deep learning model.

4. The method of claim 2, further comprising storing all solutions created by the mathematical solver and all simulation results created by the reinforcement learning model.

5. The method of claim 4, wherein the reinforcement learning model is trained using the stored solutions created by the mathematical solver and the simulation optimization model.

6. The method of claim 5, wherein the reinforcement learning module compares an output solution to the problem provided by one of the mathematical solver and the simulation optimization model to a solution derived by the reinforcement learning module.

7. The method of claim 1, wherein the predicting comprises determining whether the use case characteristics indicates that the problem is deterministic or stochastic.

8. A system, comprising:
one or more processors; and
a memory coupled to the one or more processors, the memory configured to store a plurality of instructions executable by the one or more processors and when executed by the one or more processors cause the one or more processors to at least:
receive a payload including a request for optimizing a service;
process the payload, using a meta learning classifier, the processing the payload includes steps to at least:
extract a problem and use case characteristics from the payload;
predict at least one machine learning model capable of solving the problem having the use case characteristics; and
execute the at least one machine learning model to solve the problem;
output a solution to the problem for optimizing the service from the at least one machine learning model; and
provide the solution to a computing device.

9. The system of claim 8, wherein the at least one machine learning model comprise one of a mathematical solver, a simulation optimization model, and a reinforcement learning model.

10. The system of claim 9, wherein:
the mathematical solver includes programs capable of solving a combination of a linear programming (LP), non-linear programming (NPL), and mixed integer programming (MIP);
the simulation optimization model includes programs capable of performing stochastic programming, a Monte Carlo simulation, and a discrete event simulation; and
the reinforcement learning model includes a neural network or a deep learning model.

11. The system of claim 9, further comprising storing all solutions created by the mathematical solver and all simulation results created by the reinforcement learning model.

12. The system of claim 11, wherein the reinforcement learning model is trained using the stored solutions created by the mathematical solver and the simulation optimization model.

13. The system of claim 12, wherein the reinforcement learning module compares an output solution to the problem provided by one of the mathematical solver and the simulation optimization model to a solution derived by the reinforcement learning module.

14. The system of claim 8, wherein the predicting comprises determining whether the use case characteristics indicates that the problem is deterministic or stochastic.

15. A non-transitory computer-readable memory storing a plurality of instructions executable by one or more processors, the plurality of instructions comprising instructions that when executed by the one or more processors cause the one or more processors to perform operations comprising:
receiving a payload including a request for optimizing a service;
processing the payload, using a meta learning classifier, the processing comprising:
extracting a problem and use case characteristics from the payload;
predicting at least one machine learning model capable of solving the problem having the use case characteristics; and
executing the at least one machine learning model to solve the problem;
outputting a solution to the problem for optimizing the service from the at least one machine learning model; and
providing the solution to a computing device.

16. The non-transitory computer-readable medium of claim 15, wherein the at least one machine learning model comprise one of a mathematical solver, a simulation optimization model, and a reinforcement learning model.

17. The non-transitory computer-readable medium of claim 16, wherein:
the mathematical solver includes programs capable of solving a combination of a linear programming (LP), non-linear programming (NPL), and mixed integer programming (MIP);
the simulation optimization model includes programs capable of performing stochastic programming, a Monte Carlo simulation, and a discrete event simulation; and
the reinforcement learning model includes a neural network or a deep learning model.

18. The non-transitory computer-readable medium of claim 16, further comprising storing all solutions created by the mathematical solver and all simulation results created by the reinforcement learning model.

19. The non-transitory computer-readable medium of claim 18, wherein the reinforcement learning model is trained using the stored solutions created by the mathematical solver and the simulation optimization model.

20. The non-transitory computer-readable medium of claim 19, wherein the reinforcement learning module compares an output solution to the problem provided by one of the mathematical solver and the simulation optimization model to a solution derived by the reinforcement learning module.

21. The non-transitory computer-readable medium of claim 15, wherein the predicting comprises determining whether the use case characteristics indicates that the problem is deterministic or stochastic.
